(19) United States
(12) Patent Application Publication
(10) Pub. No.: US 2003/0202496 A1
(43) Pub. Date: Oct. 30, 2003

(54) Automatic gain control in a WLAN receiver having improved settling speed

(76) Inventors: Wolfram Kluge, Dresden (DE); Lutz Dathe, Dresden (DE); Rene Freigang, Dresden (DE)

Correspondence Address: B. Noel Kivlin, Conley, Rose, & Tayon, P.C., P.O. Box 398, Austin, TX, 78767, US

(21) Appl. No.: 10/283,584

(22) Filed: Oct. 30, 2002

(30) Foreign Application Priority Data
Apr. 30, 2002 (DE) 102 19 358.4

(51) Int. Cl. H04Q 7/24; H04B 1/06

(52) U.S. Cl. 370/338; 455/234.1

(57) ABSTRACT

In the field of radio communication technology a WLAN (wireless local area network) receiver that has an AGC (automatic gain control unit) is provided, and a corresponding method of operating a WLAN receiver. In order to provide an improved WLAN receiver with a more efficient AGC unit having a reduced settling speed and a higher accuracy, a WLAN receiver is provided that comprises at least one controllable amplifier for receiving an input signal and generating an amplified input signal. The WLAN receiver further comprises an AGC controller for evaluating a signal strength of the amplified input signal and generating a control signal for controlling the gain of the controllable amplifier dependent thereon. The AGC controller is further arranged for evaluating a signal strength of the input signal and generating the control signal dependent on the signal strength of said input signal.

### BACKGROUND OF THE INVENTION

1. Field of the Invention

The present invention relates to radio communication technology, and more particularly to WLAN (wireless local area network) receivers having an automatic gain control unit.

2. Description of the Related Art

A communication apparatus, such as a WLAN (wireless local area network) receiver is generally provided with an AGC (automatic gain control) circuit so that a constant output level can be maintained even when the level of the received signal changes. Particularly, when the communication apparatus is a mobile WLAN transceiver which is used in circumstances, such that the level of a received signal significantly changes as when passing through tunnels, moving up from a plane to a hill passing through or between buildings or approaching the transmitting radio station. The apparatus requires an AGC unit which can maintain good gain control over a range from a very small received signal level to an unduly large received signal level.

Recently developed conventional WLAN receivers having an AGC unit are, for instance, shown in P. M. Stroet et al.: A ZERO-IF-SINGLE-CHIP TRANSCEIVER FOR UP TO 22 Mb/s QPSK 802.11b WIRELESS LAN, 2001 IEEE International Solid-State Circuits Conference, Session 13.5, pp. 204-205, 447, and in A. Jayaraman et al.: A FULLY INTEGRATED BROADBAND DIRECT-CONVERSION RECEIVER FOR DBS APPLICATIONS, 2000 IEEE International Solid-State Circuits Conference, TA 8.2, pp. 140-141.

FIG. 1 shows a block diagram of the main portion of a typical WLAN receiver, which comprises an AGC unit 100 of the conventional type. Such a conventional AGC unit 100 has at least one controllable amplifier 102 receiving an input signal. The amplified signal is then filtered by a low pass filter 104, thereby generating the output signal. Although in FIG. 1 the controllable amplifier 102 (which might be a low noise amplifier) is connected directly to the low pass filter 104, an additional mixer could be provided between the controllable amplifier 102 and the low pass filter 104. For controlling the gain of the controllable amplifier 102, the output signal of the low pass filter 104 is rectified by means of a rectifier 106 and compared to a plurality of thresholds by means of a comparator 108. In most cases, the rectified signal is compared to at least two thresholds to determine whether the signal is too high or too low. As a result of this comparison, an AGC controller 110 generates a new gain control word and decreases or increases the gain of the controllable amplifier 102 by a single gain step.

A conventional receiver AGC normally covers an input dynamic range of more than 80 dB. Changing the gain with the minimum gain step size, which is in the order 1 dB to 3 dB, leads to long settling times when large gain changes are necessary. Therefore, it would be desirable to perform gain steps of more than 20 dB in order to enhance the AGC's settling speed.

In conventional receivers, the nominal magnitude of the output signal is as high as possible with respect to the amplifier design in order to obtain an optimal signal-to-noise ratio. Consequently, signal magnitudes of more than 20 dB with respect to the nominal magnitude are usually limited by the amplifier and therefore cannot be used to control the AGC unit. Thus, the ratio between the nominal signal magnitude and the maximum amplifier output signal magnitude, that is the saturation value, limits the maximum gain step of conventional AGC units to about 10 dB.

In other words, conventional digital AGC units suffer from the problem, that large input signals which require large gain reduction may be saturated at the receiver output. Consequently, the signal magnitude information gets lost and gain reduction must be done in small steps resulting in a low settling speed of the gain control loop.

### SUMMARY OF THE INVENTION

Therefore, an improved WLAN (wireless local area network) receiver is provided with a more efficient AGC (automatic gain control) unit that may have a reduced settling speed and a higher accuracy.

According to one embodiment, a WLAN receiver has an AGC unit that comprises at least one controllable amplifier for receiving an input signal and generating an amplified input signal. The AGC unit further comprises an AGC controller for evaluating a signal strength of the amplified input signal and generating a control signal for controlling the gain of the controllable amplifier dependent thereon. The AGC controller is further arranged for evaluating a signal strength of the input signal and generating the control signal dependent on the signal strength of said input signal.

In another embodiment, an integrated circuit chip for use in a WLAN receiver having an AGC circuitry is provided. The AGC circuitry comprises at least one controllable amplifier unit for receiving an input signal and generating an amplified input signal. The AGC circuitry further comprises an AGC controller unit for evaluating a signal strength of the amplified input signal and generating a control signal for controlling the gain of the controllable amplifier unit dependent thereon. The AGC controller unit is further arranged for evaluating a signal strength of the input signal and generating the control signal dependent on the signal strength of said input signal.

In a further embodiment, a method of operating a WLAN receiver having an AGC unit is provided. The AGC unit comprises at least one controllable amplifier. In the method, an input signal is received and the controllable amplifier is operated to generate an amplified input signal. Then a control signal for controlling the gain of the controllable amplifier is generated dependent on the signal strength of the amplified input signal and the signal strength of the input signal.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention as illustrated in the accompanying drawings, wherein:

FIG. 1 is a block diagram illustrating the automatic gain control technique;

FIG. 2 is a block diagram of an automatic gain control unit according to a first embodiment;

FIG. 3 is a flowchart of a method for operating a receiver having an automatic gain control unit; and

FIG. 4 is a block diagram of an automatic gain control unit according to a second embodiment.

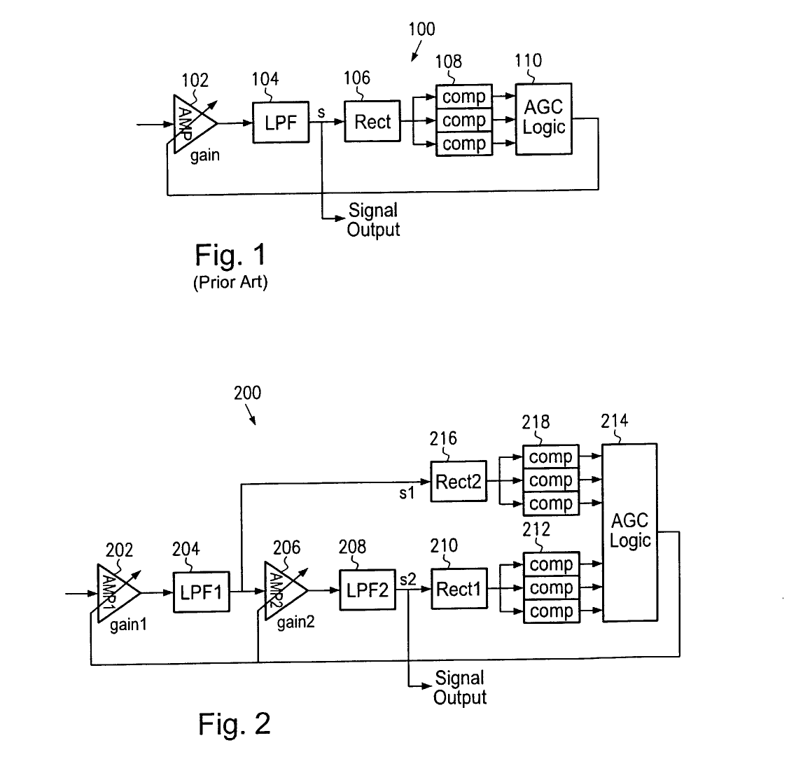

### DETAILED DESCRIPTION OF THE INVENTION

The illustrated embodiments of the present invention will be described with reference to the figure drawings, wherein like elements and structures are indicated by like reference numbers.

Referring now to the drawings and in particular to FIG. 2 which is a block diagram of an automatic gain control (AGC) unit for controlling a gain of a signal received by a receiver according to a first embodiment, the AGC unit comprises two amplifiers 202, 206 which are controllable by an control signal output from AGC controller 214. The output of each amplifier 202, 206 is input into a low pass filter 204, 208 and the amplified input signal S2, which represents the overall signal output of the AGC unit, is rectified by the first rectifier 210 and then compared to three thresholds 212. Of course, the number of thresholds can be less or more than the three thresholds depicted in FIG. 2. On the basis of this comparison, the AGC controller 214 evaluates the signal strength of S2 and outputs accordingly a gain control signal to both amplifiers 202 and 206. Additionally, the input signal S1 of the controllable amplifier 206 is rectified and directly compared to thresholds 218 and also input into the AGC controller 214. As the magnitude of the signal S1 is lower than the magnitude of the amplified S2 by the gain of amplifier 206, the output of the rectifier 216 covers a signal range that is enhanced by the factor gain2.

The controlling of the two amplifiers 202 and 206 is necessary in most cases, as the overall receiver gain normally has to be reduced to about 0 dB. As changing gain2 of the amplifier 206 shifts the thresholds of the comparators 218 in relation to the thresholds of the comparators 212, the possible gain steps of the amplifier 206 can be set to the same values that are defined by the threshold ratios of comparator 218. This allows the logic block of the AGC controller 214 to multiplex the comparator output, which compensates for the gain to change completely.

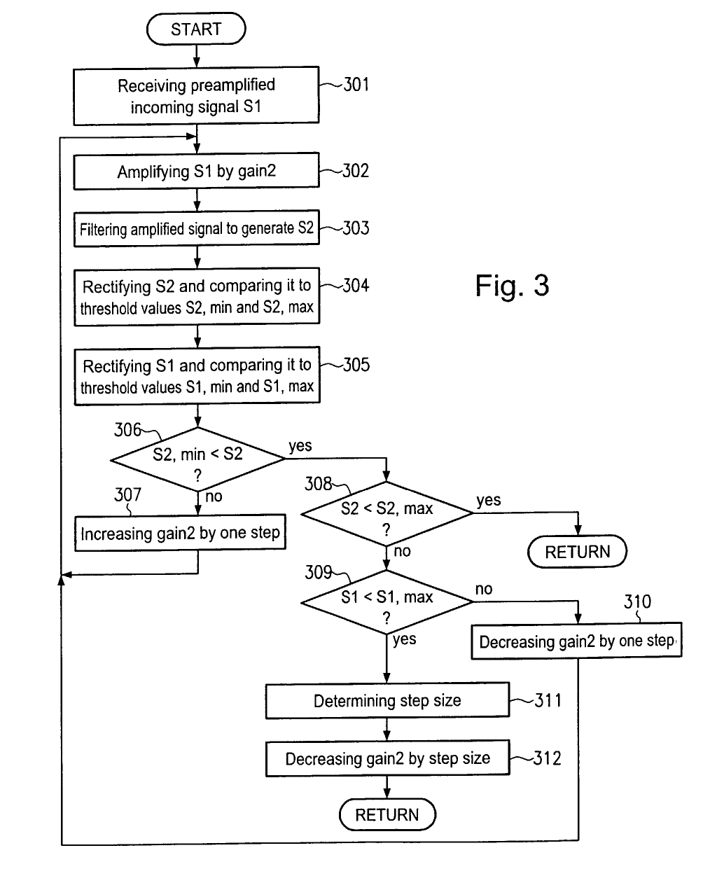

Referring now to FIG. 3, a flowchart of a method for operating a receiver having an AGC unit as illustrated in FIG. 2 is shown. The process begins with receiving a pre-amplified incoming signal S1 at step 301. In a subsequent step 302, this signal S1 is amplified by gain2. In step 303, the amplified signal is filtered thereby generating the signal S2 as shown by step 304. Signal S2 is rectified and compared to first threshold values S2,min and S2,max. In this step it is of course possible to compare S2 only to a single threshold value or to a plurality of threshold values.

According to an advantageous embodiment, the pre-amplified incoming signal S1 is rectified and compared to second threshold values S1,min and S1,max (step 305). In this step, also a plurality of threshold values can be provided. As shown by step 306, it may be decided whether the signal S2 is less than the first threshold value S2, min. If this is not the case, gain2 is increased by one step because this means that the single output of the AGC unit, which is represented by S2 is not sufficiently high. The process returns from this step 307 to step 302 and amplifies S2 by the new gain2.

However, if in step 306 it is decided that S2 is higher than S2,min, it can be decided in step 308 whether S2 on the other hand is less than S2,max. When this is the case, the process returns and the optimal gain of the controllable amplifier has been achieved. However, when in step 308 it is decided that S2 is not less than S2,max, it may be decided in step 309 whether S1 is less than S1,max. If this is not the case, already the incoming signal S1 is too high and gain2 is decreased by one step (step 310). However, in case that S1 is less than S1,max according to the decision made in step 309, a step size is determined in step 311. In step 312, the gain2 is decreased by the determined step size of step 311 and subsequently, the process is finished.

The RETURN steps of FIG. 3 may signify a closed loop to finish the AGC cycle, but this is not necessarily the case.

Although according to the embodiment shown in FIG. 3 both, the amplified and the non-amplified input signals are used for generating the gain control word, the AGC controller 214 can also be switchable to generate the control signal dependent on the signal strength of either of the two signals.

FIG. 3 depicts only one possible embodiment of producing the required gain reduction during an AGC cycle. However, there also exist other embodiments, wherein for instance all comparator outputs can be connected to a coder. The output signal of this coder may represent the necessary gain reduction during an AGC clock cycle.

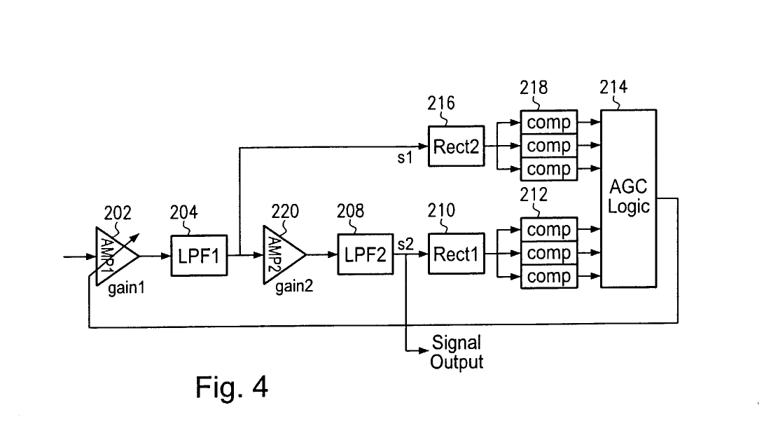

In FIG. 4 an alternative embodiment is shown where the controllable amplifier 206 is replaced by a non-controllable amplifier 220 with a fixed gain2. This embodiment is simpler with respect to its construction, but is not able to reduce the overall gain of the AGC unit to the factor 1 (that is to 0 dB).

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention.

In addition, those areas in which it is believed that those ordinary skilled in the art are familiar have not been described herein in order not to unnecessarily obscure the invention described herein.

Accordingly, it is to be understood that the invention is not to be limited by the specific illustrated embodiments but only by the scope of the appended claims.

What is claimed is:

1. A WLAN (wireless local area network) receiver having an AGC (automatic gain control) unit comprising:
at least one controllable amplifier for receiving an input signal and generating an amplified input signal,
an AGC controller for evaluating a signal strength of said amplified input signal and generating a control signal for controlling the gain of said controllable amplifier dependent thereon,
wherein said AGC controller is further arranged for evaluating a signal strength of said input signal and generating said control signal dependent on the signal strength of said input signal.

2. The WLAN receiver of claim 1, wherein said AGC unit further comprises:
at least one low pass filter for filtering said amplified input signal, said AGC controller being arranged to receive the filtered signal for evaluating the signal strength.

3. The WLAN receiver of claim 1, wherein said AGC unit further comprises a first rectifier for rectifying said amplified input signal and for generating a first rectified signal, and wherein said AGC controller is arranged for evaluating the signal strength of said first rectified signal.

4. The WLAN receiver of claim 1, wherein said AGC unit further comprises a first comparator for comparing the signal strength of said amplified input signal to at least one first threshold value, and wherein said AGC controller is arranged for evaluating the signal strength of said amplified input signal on the basis of the comparison result.

5. The WLAN receiver of claim 4, wherein said AGC unit further comprises a second comparator for comparing the signal strength of said input signal to at least one second threshold value, and wherein said AGC controller is arranged for evaluating the signal strength of said input signal on the basis of the comparison result.

6. The WLAN receiver of claim 5, wherein said second comparator comprises a plurality of comparator units each for comparing the signal strength of said input signal to one of said second threshold values.

7. The WLAN receiver of claim 6, wherein said AGC controller comprises a multiplexer for multiplexing the outputs of said comparator units.

8. The WLAN receiver of claim 6, wherein said AGC controller is arranged for controlling the gain of said controllable amplifier to assume one of a plurality of gain values, and wherein each second threshold value corresponds to one of said plurality of gain values.

9. The WLAN receiver of claim 1, wherein said AGC controller is arranged for generating said control signal dependent on both the signal strength of the amplified input signal and the signal strength of the input signal.

10. The WLAN receiver of claim 1, wherein said AGC controller is switchable to generate said control signal either dependent on the signal strength of the amplified input signal or dependent on the signal strength of the input signal.

11. The WLAN receiver of claim 10, wherein said AGC controller is arranged for switching to an operational mode where the AGC controller generates said control signal dependent on the signal strength of the input signal when the signal strength of the amplified input signal exceeds a predetermined limit.

12. The WLAN receiver of claim 1, being IEEE 802.11b compliant.

13. The WLAN receiver of claim 1, wherein said AGC unit further comprises an amplifier having a fixed gain connected in series with said at least one controllable amplifier, wherein the AGC controller is arranged for evaluating the signal strength of the input signal amplified by both amplifiers, evaluating the signal strength of the input signal amplified only by the controllable amplifier and generating a control signal for controlling the gain of said controllable amplifier dependent on the results of both evaluations.

14. An integrated circuit chip for use in a WLAN (wireless local area network) receiver having an AGC (automatic gain control) circuitry comprising:
at least one controllable amplifier unit for receiving an input signal and generating an amplified input signal,
an AGC controller unit for evaluating a signal strength of said amplified input signal and generating a control signal for controlling the gain of said controllable amplifier unit dependent thereon,
wherein said AGC controller unit is further arranged for evaluating a signal strength of said input signal and generating said control signal dependent on the signal strength of said input signal.

15. A method of operating a WLAN (wireless local area network) receiver having an AGC (automatic gain control) unit comprising at least one controllable amplifier, said method comprising:
receiving an input signal;
operating said controllable amplifier to generate an amplified input signal; and
generating a control signal for controlling the gain of said controllable amplifier dependent on the signal strength of said amplified input signal and the signal strength of said input signal.

16. The method of claim 15, further comprising:
evaluating the signal strength of said amplified input signal by comparing the signal strength of said amplified input signal to at least one first threshold value.

17. The method of claim 16, wherein the step of generating a control signal for controlling the gain of said controllable amplifier comprises:
increasing the gain of said controllable amplifier when the amplified input signal is less than said at least one first threshold value.

18. The method of claim 17, wherein the gain of said controllable amplifier is increased by predefined steps.

19. The method of claim 15, further comprising:
evaluating the signal strength of said input signal by comparing the signal strength of said input signal to at least one second threshold value.

20. The method of claim 19, wherein generating a control signal for controlling the gain of said controllable amplifier dependent on the signal strength of said input signal comprises:
decreasing the gain of said controllable amplifier by a predefined step when the signal strength of said input signal is greater than a higher one of said at least one second threshold value.

21. The method of claim 19, wherein generating a control signal for controlling the gain of said controllable amplifier dependent on the signal strength of said input signal comprises:
determining a gain step size, when the signal strength of said input signal is less than said at least one second threshold value, and
decreasing the gain of said controllable amplifier by the determined gain step size.

22. The method of claim 8, further comprising:
filtering said input signal by means of a low pass filter.

23. The method of claim 8, further comprising:
rectifying said input signal.

24. The method of claim 8, further comprising:
filtering said amplified input signal by means of a low pass filter.

25. The method of claim 8, further comprising:
rectifying said amplified input signal.

26. The method of claim 19, wherein said AGC controller controls the gain of said controllable amplifier to assume one of a plurality of gain values, and wherein each second threshold value corresponds to one of said plurality of gain values.

27. The method of claim 15, wherein said AGC controller generates said control signal dependent on both the signal strength of the amplified input signal and the signal strength of the input signal.

28. The method of claim 15, wherein said AGC controller is switched to generate said control signal either dependent on the signal strength of the amplified input signal or dependent on the signal strength of the input signal.

29. The method of claim 28, wherein said AGC controller switches to an operational mode where the AGC controller generates said control signal dependent on the signal strength of the input signal when the signal strength of the amplified input signal exceeds a predetermined limit.

30. The method of claim 15, said WLAN receiver being IEEE 802.11b compliant.
